(19) United States
(12) Patent Application Publication
(10) Pub. No.: US 2024/0089655 A1
(43) Pub. Date: Mar. 14, 2024

(54) AUDIO DEVICE, AUDIO SYSTEM, PROGRAM, AND METHOD FOR SETTING AUDIO PLAYBACK ENVIRONMENT

(71) Applicant: D&M Holding Inc., Kanagawa (JP)

(72) Inventor: KENJI SUZUKI, Fukushima (JP)

(73) Assignee: D&M Holding Inc., Kanagawa (JP)

(21) Appl. No.: 18/262,478

(22) PCT Filed: Sep. 28, 2021
(86) PCT No.: PCT/JP2021/035536

§ 371 Date: Jul. 21, 2023

(30) Foreign Application Priority Data
Jan. 21, 2021 (JP) 2021-008308

(51) Int. Cl. H04R 3/04

(52) U.S. Cl. CPC H04R 3/04

(57) ABSTRACT

[Problem] To provide technology for setting an audio playback environment compatible with adding speakers. [Solution] An audio device 1 corrects, for each connected speaker 2, an audio playback signal output from speakers 2-1 to 2-3, in accordance with filter information registered in association with that speaker 2. When a new speaker 2 is connected, identification information is acquired from that speaker 2, the identification information is used to query a management server 4, and acoustic properties of that speaker 2 are acquired from the management server 4. The acquired acoustic properties are then compared to target prescribed acoustic properties, filter information is generated for causing the audio playback signal output from the speaker 2 to approach the prescribed acoustic properties, and the generated filter information is registered in association with the speaker 2.

### TECHNICAL FIELD

The present invention relates to a technology of setting an audio reproduction environment using a plurality of speakers.

### BACKGROUND ART

An audio device that reproduces a multi-channel audio signal with the use of a plurality of speakers has been known. For example, an audio device as described in Patent Literature 1 amplifies an audio reproduction signal for each channel of a multi-channel audio signal, and outputs the audio reproduction signal from a speaker corresponding to the channel.

In recent years, audio systems using a sound bar have gained popularity. A sound bar has speakers for a plurality of channels built therein, and an environment for reproducing multi-channel audio can be accomplished with a single sound bar (a one-body type), or a combination of a sound bar and a subwoofer (a 2-unit type).

### CITATION LIST

### Patent Literature

[PTL 1] JP 2002-367290 A

### SUMMARY OF INVENTION

### Problem to be Solved by Invention

Speakers for a plurality of channels that are built in a sound bar and a subwoofer used in combination with the sound bar are tuned so as to have acoustic characteristics (frequency-sound pressure level characteristics) unified on the whole, and an excellent environment for reproducing multi-channel audio can thus be accomplished. However, with an audio system using a sound bar, addition of a speaker that is not expected to be used alongside the sound bar may result in poor reproduction of multi-channel audio due to a mismatch in acoustic characteristics between the added speaker and the sound bar that has been in use.

The present invention has been made in view of the circumstance described above, and an object of the present invention is to provide a technology of setting an audio reproduction environment adaptable to the addition of a speaker.

### Solution to Problem

In order to solve the above-mentioned problem, an audio device of one embodiment of the present invention corrects, for each speaker connected thereto, an audio reproduction signal to be output from the speaker in accordance with filtering information registered in association with the speaker. When a new speaker is connected, the audio device acquires identification information (for example, a manufacturer name and a model name) from the new speaker, uses the identification information to issue an inquiry to a server, and acquires acoustic characteristics of the new speaker from the server. The audio device then compares the acquired acoustic characteristics to predetermined acoustic characteristics to be aimed for, generates filtering information so that an audio reproduction signal output from the new speaker is close to the predetermined acoustic characteristics, and registers the generated filtering information in association with the new speaker.

For example, according to one embodiment of the present invention, there is provided an audio device for reproducing and outputting an audio signal with use of a plurality of speakers, the audio device including: filtering information storage means for storing filtering information for each one of the plurality of speakers connected to the audio device; correction means for correcting, for each one of the plurality of speakers connected to the audio device, an audio reproduction signal to be output to the each one of the plurality of speakers, in accordance with the filtering information of the each one of the plurality of speakers which is stored in the filtering information storage means; identification information acquisition means for acquiring, when one of the plurality of speakers is newly connected, identification information of the newly connected one of the plurality of speakers from the newly connected one of the plurality of speakers; acoustic characteristics acquisition means for acquiring acoustic characteristics of the newly connected one of the plurality of speakers from a server for managing acoustic characteristics of each of the plurality of speakers, by notifying the identification information acquired by the identification information acquisition means to the server; filtering information generation means for generating filtering information for making an audio reproduction signal output from the newly connected one of the plurality of speakers close to predetermined acoustic characteristics by comparing the acoustic characteristics acquired by the acoustic characteristics acquisition means to the predetermined acoustic characteristics; and filtering information registration means for registering the filtering information generated by the filtering information generation means, in the filtering information storage means in association with the newly connected one of the plurality of speakers.

### Advantageous Effects of Invention

In the present invention, the acoustic characteristics of the newly connected speaker are acquired from the server, the acquired acoustic characteristics are compared to the predetermined acoustic characteristics to be aimed for, and the filtering information is generated so that an audio reproduction signal output from the newly connected speaker is close to the predetermined acoustic characteristics. An audio reproduction signal to be output from the newly connected speaker is corrected in accordance with the generated filtering information. According to the present invention, an excellent audio reproduction environment can thus be accomplished irrespective of the addition of a new speaker.

### BRIEF DESCRIPTION OF DRAWINGS

FIG. 1 is a schematic configuration diagram of an audio system according to one embodiment of the present invention.

FIG. 2 is a sequence diagram for illustrating operation of setting an audio reproduction environment in the audio system according to the one embodiment of the present invention in a case in which one of speakers (2) is newly connected to an audio device (1).

FIG. 3 is a schematic function configuration diagram of the audio device (1).

FIG. 4 is a flow chart for illustrating audio reproduction environment setting processing of the audio device (1).

FIG. 5 is a schematic function configuration diagram of each of the speakers (2).

FIG. 6 is a flow chart for illustrating audio device connection processing of the speakers (2).

### DESCRIPTION OF EMBODIMENTS

One embodiment of the present invention is described below with reference to the drawings.

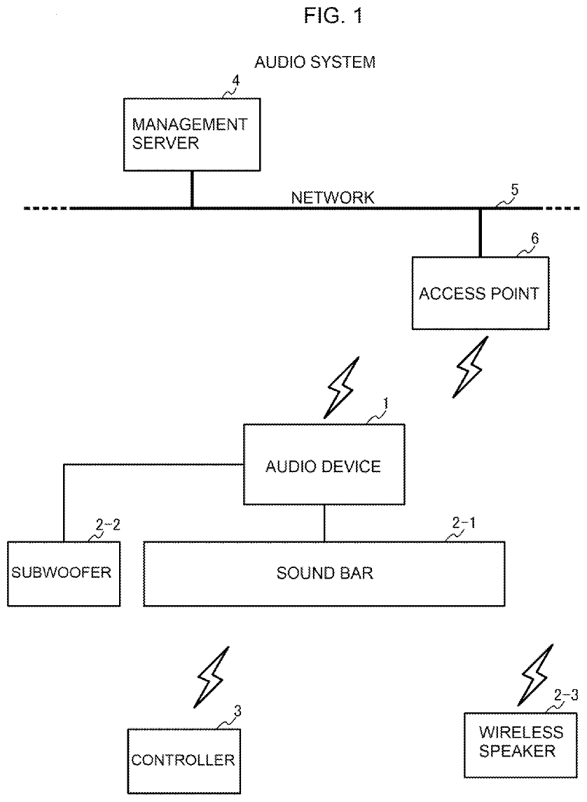

FIG. 1 is a schematic configuration diagram of an audio system according to this embodiment.

As illustrated in the figure, the audio system according to this embodiment includes an audio device 1 connected to a management server 4 via an access point 6 and a network 5, which is a WAN, a LAN, or the like, a sound bar 2-1, a subwoofer 2-2, and a wireless speaker 2-3 (those are hereinafter also referred to as “speakers 2”), which are connected to the audio device 1, and a controller 3 for remotely operating the audio device 1.

The sound bar 2-1 and the subwoofer 2-2 are connected to the audio device 1 by cables, and the wireless speaker 2-3 is connected by wireless connection to the audio device 1 via the access point 6. However, both of cable connection and wireless connection are usable for connection between the speakers 2 and the audio device 1.

The controller 3 is configured from a wireless terminal such as a smartphone or a tablet personal computer (PC), and connects by wireless connection to the audio device 1 via the access point 6, to thereby remotely execute various types of operation including audio reproduction control on the audio device 1.

The audio device 1 reproduces audio content by following a user's instruction received via the controller 3, and outputs an audio reproduction signal of the audio content from the speakers 2 connected to the audio device 1. The audio device 1 corrects, for each one of the speakers 2 connected to the audio device 1, the audio reproduction signal to be output from the speaker 2 in accordance with filtering information registered in association with the speaker 2. This gives the sound bar 2-1, the subwoofer 2-2, and the wireless speaker 2-3 acoustic characteristics (frequency-sound pressure level characteristics) unified on the whole, with the result that an excellent audio reproduction environment is accomplished.

The management server 4 manages, for each one of the speakers 2, acoustic characteristics of the speaker 2 in association with identification information (for example, a manufacturer name and a model name) of the speaker 2. The audio device 1 acquires acoustic characteristics of one of the speakers 2 that has newly been connected to the audio device 1 from the management server 4, compares the acquired acoustic characteristics to predetermined acoustic characteristics to be aimed for, and generates filtering information for making an audio reproduction signal output from the newly connected speaker 2 close to the predetermined acoustic characteristics. The audio device 1 then registers the generated filtering information in association with the newly connected speaker 2.

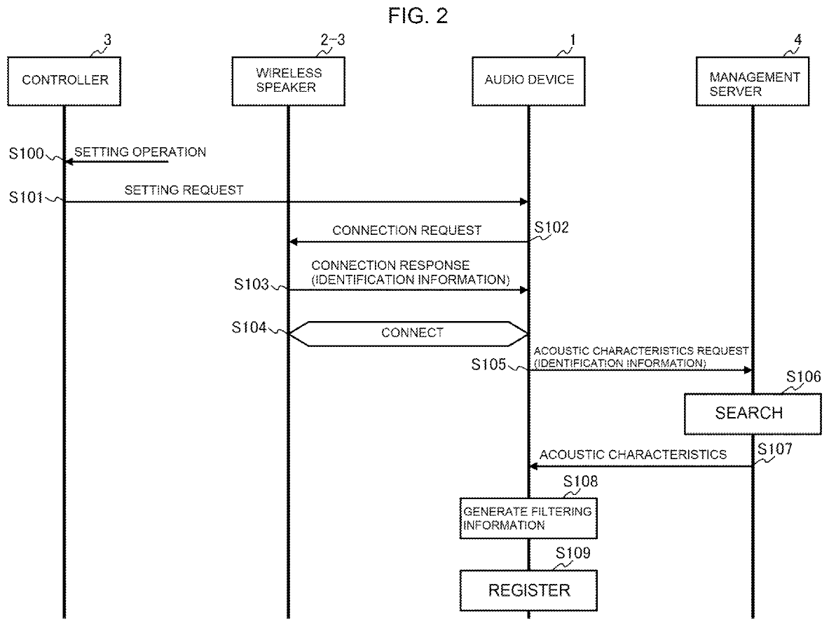

FIG. 2 is a sequence diagram for illustrating operation of setting an audio reproduction environment in the audio system according to this embodiment in a case in which one of the speakers 2 is newly connected to the audio device 1.

Description given here takes as an example a case of newly connecting the wireless speaker 2-3 to the audio device 1 to which the sound bar 2-1 and the subwoofer 2-2 have already been connected. It is assumed here that the wireless speaker 2-3 is connected by wireless connection to the access point 6.

The controller 3 receives user's setting operation accompanied by specification of the wireless speaker 2-3 as a destination to which an audio reproduction signal is output (Step S100), and transmits a setting request accompanied by the specification of the wireless speaker 2-3 to the audio device 1 via the access point 6 (Step S101). The audio device 1 receives the setting request and transmits, via the access point 6, a connection request to the wireless speaker 2-3 (Step S102).

The wireless speaker 2-3 receives the setting request from the audio device 1 via the access point 6, returns a connection response accompanied by identification information (for example, a manufacturer name and a model name) of the wireless speaker 2-3 to the audio device 1 (Step S103), and connects to the audio device 1 (Step S104).

Next, the audio device 1 transmits an acoustic characteristics request accompanied by the identification information of the wireless speaker 2-3 to the management server 4 via the access point 6 and the network 5 (Step S105). The management server 4 receives the acoustic characteristics request, searches for acoustic characteristics of the wireless speaker 2-3 with the identification information of the wireless speaker 2-3 as a key (Step S106), and transmits the acoustic characteristics of the wireless speaker 2-3 to the audio device 1 (Step S107).

Next, the audio device 1 compares the acoustic characteristics of the wireless speaker 2-3 acquired from the management server 4 to predetermined acoustic characteristics to be aimed for, and generates filtering information for making an audio reproduction signal to be output to the wireless speaker 2-3 close to the predetermined acoustic characteristics (Step S108). The audio device 1 then registers the generated filtering information in association with the wireless speaker 2-3 (Step S109).

Details of the audio device 1 and the speakers 2 which are included in the audio system according to this embodiment are described next. An existing controller is usable as the controller 3, and a detailed description of the controller 3 is accordingly omitted.

First, details of the audio device 1 are described.

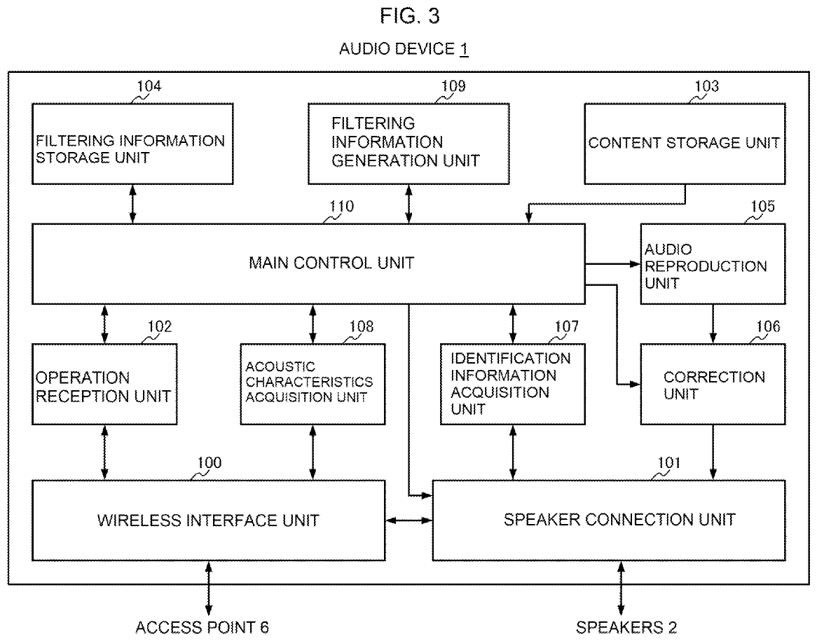

FIG. 3 is a schematic function configuration diagram of the audio device 1.

As illustrated in the figure, the audio device 1 includes a wireless interface unit 100, a speaker connection unit 101, an operation reception unit 102, a content storage unit 103, a filtering information storage unit 104, an audio reproduction unit 105, a correction unit 106, an identification information acquisition unit 107, an acoustic characteristics acquisition unit 108, a filtering information generation unit 109, and a main control unit 110.

The wireless interface unit 100 is an interface for connecting by wireless connection to the access point 6.

The speaker connection unit 101 is an interface for connecting to the speakers 2 via cable connection terminals (not shown) or the wireless interface unit 100. For example, in FIG. 1, the speaker connection unit 101 is connected by cable connection to the sound bar 2-1 and to the subwoofer 2-2 via cable connection terminals, and is connected by wireless connection to the wireless speaker 2-3 via the wireless interface unit 100.

The operation reception unit 102 receives, from the controller 3 via the wireless interface unit 100, various types of operation including setting operation that is accompanied by specification of a destination to which an audio reproduction signal is output, audio reproduction control operation, and the like.

The content storage unit 103 stores audio content of tunes.

The filtering information storage unit 104 stores, for each one of the speakers 2 connected to the speaker connection unit 101, filtering information for correcting an audio reproduction signal to be output from the speaker 2.

The audio reproduction unit 105 reproduces audio content stored in the content storage unit 103, and outputs an audio reproduction signal for each of the speakers 2 connected to the speaker connection unit 101.

The correction unit 106 corrects the audio reproduction signal output from the audio reproduction unit 105 for each of the speakers 2 connected to the speaker connection unit 101, in accordance with the filtering information stored in the filtering information storage unit 104 in association with the corresponding one of the speakers 2, and transmits the corrected signal to the corresponding one of the speakers 2 via the speaker connection unit 101.

The identification information acquisition unit 107 transmits the connection request to one of the speakers 2 via the speaker connection unit 101, and receives the connection response from the speaker 2, to thereby acquire the identification information (for example, a manufacturer name and a model name) of the speaker 2.

The acoustic characteristics acquisition unit 108 transmits the acoustic characteristics request accompanied by the identification information of one of the speakers 2 to the management server 4 via the wireless interface unit 100, to thereby acquire acoustic characteristics of the speaker 2 from the management server 4.

The filtering information generation unit 109 compares the acoustic characteristics of the speaker 2 acquired by the acoustic characteristics acquisition unit 108 to predetermined acoustic characteristics to be aimed for, and generates filtering information for making an audio reproduction signal to be output from the speaker 2 close to the predetermined acoustic characteristics.

The main control unit 110 executes overall control of the units 100 to 109 of the audio device 1.

The function configuration of the audio device 1 that is illustrated in FIG. 3 may be implemented in the form of hardware by an integrated logic IC such as an application-specific integrated circuit (ASIC) or a field-programmable gate array (FPGA), or may be implemented in the form of software by a computer such as a digital signal processor (DSP). The function configuration may also be implemented by a CPU by loading a predetermined program out of an auxiliary storage device onto a memory and executing the program on a general-purpose computer such as a PC including the CPU, the memory, the auxiliary storage device, which is a flash memory, a hard disk drive, or the like, a wireless LAN adaptor, and a speaker connection terminal.

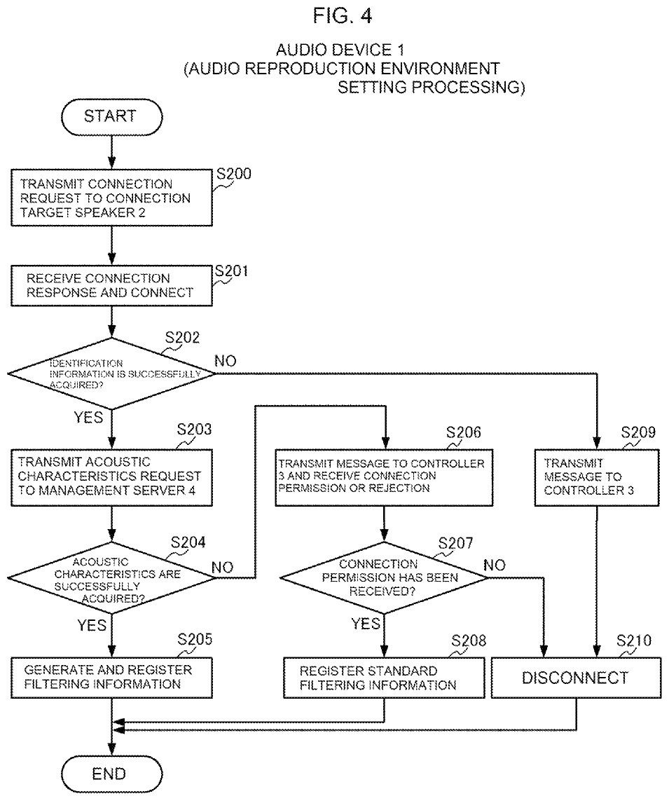

FIG. 4 is a flow chart for illustrating audio reproduction environment setting processing of the audio device 1.

This flow is started when the operation reception unit 102 receives, from the controller 3 via the wireless interface unit 100, a setting request accompanied by specification of one of the speakers 2 that is a new connection target (hereinafter referred to as “connection target speaker 2”).

First, the main control unit 110 notifies the identification information acquisition unit 107 of an address (when the connection target speaker 2 is connected by wireless connection) or a cable connection terminal (when the connection target speaker 2 is connected by a cable) of the connection target speaker 2 specified in the setting request received by the operation reception unit 102 from the controller 3, and instructs the identification information acquisition unit 107 to acquire identification information of the connection target speaker 2.

When receiving the instruction, the identification information acquisition unit 107 transmits a connection request to the connection target speaker 2 identified by the address notified from the main control unit 110 (when the connection target speaker 2 is connected by wireless connection) via the speaker connection unit 101 and via the wireless interface unit 100, or transmits a connection request to the connection target speaker 2 (when the connection target speaker 2 is connected by a cable) via the speaker connection unit 101 and via the cable connection terminal notified from the main control unit 110 (Step S200).

Next, the speaker connection unit 101 receives a connection response from the connection target speaker 2 via the wireless interface unit 100 (when the connection target speaker 2 is connected by wireless connection), or via the cable connection terminal (when the connection target speaker 2 is connected by a cable), and connects to the connection target speaker 2 in a manner that enables transmission of an audio reproduction signal to the connection target speaker 2 (Step S201).

In a case in which the connection response received by the speaker connection unit 101 from the connection target speaker 2 includes identification information of the connection target speaker 2 (YES in Step S202), the identification information acquisition unit 107 notifies the identification information to the main control unit 110. The main control unit 110 notifies the identification information received from the identification information acquisition unit 107 to the acoustic characteristics acquisition unit 108, and instructs the acoustic characteristics acquisition unit 108 to acquire acoustic characteristics of the connection target speaker 2.

The acoustic characteristics acquisition unit 108 receives the instruction, and transmits an acoustic characteristics request accompanied by specification of the identification information of the connection target speaker 2 to the management server 4 via the wireless interface unit 100 (Step S203). When the acoustic characteristics of the connection target speaker 2 are acquired from the management server 4 (YES in Step S204), the acoustic characteristics acquisition unit 108 notifies the acoustic characteristics to the main control unit 110.

The main control unit 110 receives the acoustic characteristics from the acoustic characteristics acquisition unit 108, notifies the acoustic characteristics to the filtering information generation unit 109, and instructs the filtering information generation unit 109 to generate filtering information. The filtering information generation unit 109 receives the instruction, compares the acoustic characteristics received from the main control unit 110 to predetermined acoustic characteristics which are registered in advance as acoustic characteristics to be aimed for, and generates filtering information for making an audio reproduction signal output from the connection target speaker 2 close to the predetermined acoustic characteristics. The main control unit 110 then registers the filtering information generated by the filtering information generation unit 109 in the filtering information storage unit 104 in association with the connection target speaker 2 (Step S205).

In a case in which the acoustic characteristics acquisition unit 108 fails to acquire the acoustic characteristics of the connection target speaker 2 from the management server 4 in Step S204 (NO in Step S204), on the other hand, the acoustic characteristics acquisition unit 108 notifies the main control unit 110 of the failure. In the case of a failure to acquire the acoustic characteristics of the connection target speaker 2 from the management server 4, the main control unit 110 instructs the operation reception unit 102 to notify an error.

When receiving the instruction, the operation reception unit 102 transmits, to the controller 3 via the wireless interface unit 100, a message that is an inquiry about whether to establish connection to the connection target speaker 2 in light of the circumstance that the acoustic characteristics of the connection target speaker 2 are unknown, and receives from the controller 3 an answer regarding whether to establish connection to the speaker 2 (Step S206).

In a case in which the operation reception unit 102 receives a connection permission from the controller 3 (YES in Step S207), the main control unit 110 registers, in the filtering information storage unit 104, in association with the connection target speaker 2, standard filtering information (for example, filtering information set so that an audio reproduction signal is passed through as it is) which is registered in advance (Step S208).

In a case in which the operation reception unit 102 receives connection rejection from the controller 3 (NO in Step S207), on the other hand, the main control unit 110 instructs the speaker connection unit 101 to disconnect the connection target speaker 2. The speaker connection unit 101 receives the instruction, and cuts the connection to the connection target speaker 2 in a manner that disables transmission of an audio reproduction signal to the connection target speaker 2 (Step S210).

In a case in which identification information of the connection target speaker 2 is not included in the connection response received by the speaker connection unit 101 from the connection target speaker 2 in Step S202 (NO in Step S202), the main control unit 110 instructs the operation reception unit 102 to notify an error, and also instructs the speaker connection unit 101 to disconnect the connection target speaker 2.

The operation reception unit 102 receives the instruction, and transmits, to the controller 3 via the wireless interface unit 100, a message to the effect that connection to the connection target speaker 2 is cut due to the circumstance that identification information of the speaker 2 is unknown (Step S209). The speaker connection unit 101 receives the instruction and cuts connection to the connection target speaker 2 in a manner that disables transmission of an audio reproduction signal to the speaker 2 (Step S210).

Details of the speakers 2 are described next.

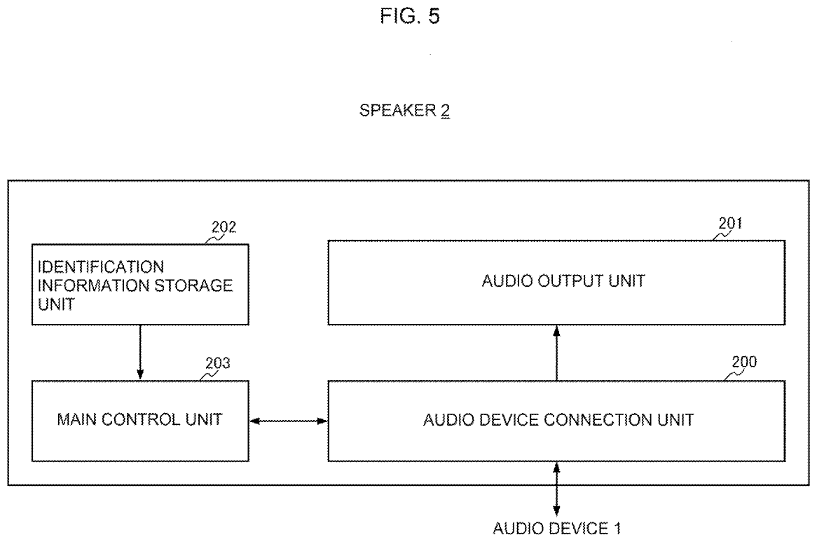

FIG. 5 is a schematic function configuration diagram of each of the speakers 2.

As illustrated in the figure, each one of the speakers 2 includes an audio device connection unit 200, an audio output unit 201, an identification information storage unit 202, and a main control unit 203.

The audio device connection unit 200 connects to the audio device 1 via a cable connection terminal (not shown) (in a case of connecting to the audio device 1 by a cable), or via a wireless interface (in a case of connecting to the audio device 1 by wireless connection).

The audio output unit 201 outputs, in the form of audio, an audio reproduction signal received via the audio device connection unit 200 from the audio device 1.

The identification information storage unit 202 stores identification information (for example, a manufacturer name and a model name) of the speaker 2.

The main control unit 203 executes overall control of the units 200 to 202 of the speaker 2.

As is the case for the function configuration of the audio device 1 illustrated in FIG. 3, the function configuration of each of the speakers 2 illustrated in FIG. 5 may be implemented in the form of hardware by an integrated logic IC such as an ASIC or an FPGA, or may be implemented in the form of software by a computer such as a DSP. The function configuration of each of the speakers 2 may also be implemented by a CPU by loading a predetermined program out of an auxiliary storage device onto a memory and executing the program on a general-purpose computer such as a PC including the CPU, the memory, the auxiliary storage device, which is a flash memory, a hard disk drive, or the like, a wireless LAN adaptor and/or an audio connection terminal, and a speaker.

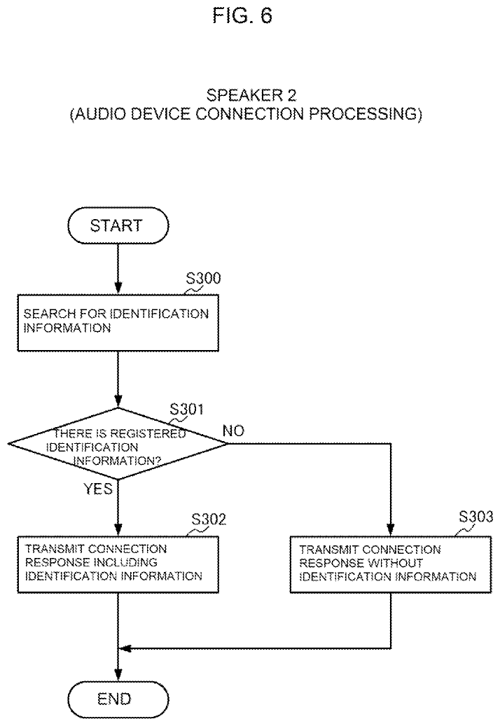

FIG. 6 is a flow chart for illustrating audio device connection processing of the speakers 2.

This flow is started when the audio device connection unit 200 receives a connection request from the audio device 1 via a cable connection terminal or the wireless interface.

The main control unit 203 refers to the identification information storage unit 202 to search for identification information of one of the speakers 2 that is its own speaker (Step S300). In a case in which the identification information of its own speaker 2 is registered in the identification information storage unit 202 (YES in Step S301), the main control unit 203 transmits a connection response accompanied by specification of this identification information to the audio device 1 via the audio device connection unit 200 (Step S302). In a case in which the identification information of its own speaker 2 is not registered in the identification information storage unit 202 (NO in Step S301), on the other hand, the main control unit 203 transmits a connection response without specification of the identification information to the audio device 1 via the audio device connection unit 200 (Step S303).

This concludes the description of the one embodiment of the present invention.

In this embodiment, the audio device 1 corrects, for each one of the speakers 2 connected to the audio device 1, an audio reproduction signal to be output from the speaker 2 in accordance with filtering information registered in association with the speaker 2. When one of the speakers 2 is newly connected, the audio device 1 acquires identification information from the newly connected speaker 2, uses this identification information to issue an inquiry to the management server 4, and acquires acoustic characteristics of the newly connected speaker 2 from the management server 4. The audio device 1 then compares the acquired acoustic characteristics to predetermined acoustic characteristics to be aimed for, generates filtering information so that an audio reproduction signal output from the newly connected speaker 2 is close to the predetermined acoustic characteristics, and registers the generated filtering information in association with the newly connected speaker 2. According to this embodiment, an excellent audio reproduction environment can thus be accomplished irrespective of the addition of a new speaker as one of the speakers 2 connected to the audio device 1.

In this embodiment, in a case of failure to acquire acoustic characteristics of the newly connected speaker 2 from the management server 4, the audio device 1 displays a message informing of the failure on the controller 3 to issue an inquiry to the user about whether to establish connection to the newly connected speaker 2. In a case in which connection rejection is received from the user with respect to the newly connected speaker 2, the audio device 1 restricts output of an audio reproduction signal from the newly connected speaker 2. According to the present invention, a failure to accomplish an audio reproduction environment that is excellent on the whole due to the addition of one of the speakers 2 that has unknown acoustic characteristics as one of the speakers 2 used in audio reproduction can thus be prevented.

The present invention is not limited to the embodiment described above, and is receptive of various modifications within the scope of the spirit of the present invention.

For example, in the embodiment described above, in the case of a failure to acquire acoustic characteristics of the newly connected speaker 2 from the management server 4, the audio device 1 displays a message informing of the failure on the controller 3 to issue an inquiry to the user about whether to establish connection to the newly connected speaker 2. However, the present invention is not limited thereto. In a case in which the audio device 1 includes a man-machine interface such as a touch panel, the audio device 1 may display a message informing of the failure on the man-machine interface to issue an inquiry to the user about whether to establish connection to the newly connected speaker 2.

In the embodiment described above, in a case of a failure to acquire identification information from the newly connected speaker 2, the audio device 1 cuts connection to the newly connected speaker 2 in a manner that disables transmission of an audio reproduction signal to the newly connected speaker 2. However, as is the case for a failure to acquire acoustic characteristics of the newly connected speaker 2, the audio device 1 may issue an inquiry to the user and, when connection permission is received from the user, may associate standard filtering information registered in advance with the speaker 2 that has failed to provide identification information.

In the embodiment described above, the audio device 1 corrects, for each one of the speakers 2 connected to the audio device 1, an audio reproduction signal to be output from the speaker 2 in accordance with filtering information registered in association with the speaker 2. However, the present invention is not limited thereto. In a case in which the speaker 2 has a function of correcting an audio reproduction signal in accordance with filtering information, the audio device 1 may transmit, prior to transmission of an audio reproduction signal to the speaker 2, a piece of filtering information registered in association with the speaker 2 to the speaker 2, in order to cause the speaker 2 to correct the audio reproduction signal in accordance with the piece of filtering information.

In the embodiment described above, communication between the audio device 1 and the wireless speaker 2-3 and communication between the audio device 1 and the controller 3 are held via the access point 6. However, the present invention is not limited thereto. Communication between the audio device 1 and the wireless speaker 2-3 and/or communication between the audio device 1 and the controller 3 may be held by short-range wireless communication such as Bluetooth (trademark).

### REFERENCE SIGNS LIST

1: audio device, 2: speaker, 2-1: sound bar
2-2: subwoofer, 2-3: wireless speaker
3: controller, 4: management server, 5: network
6: access point, 100: wireless interface unit
101: speaker connection unit, 102: operation reception unit
103: content storage unit, 104: filtering information storage unit
105: audio reproduction unit, 106: correction unit
107: identification information acquisition unit, 108: acoustic characteristics acquisition unit
109: filtering information generation unit, 110: main control unit
200: audio device connection unit, 201: audio output unit
202: identification information storage unit, 203: main control unit

1. An audio device for reproducing and outputting an audio signal with use of a plurality of speakers, the audio device comprising:
filtering information storage means for storing filtering information for each one of the plurality of speakers connected to the audio device;
correction means for correcting, for each one of the plurality of speakers connected to the audio device, an audio reproduction signal to be output to the each one of the plurality of speakers, in accordance with the filtering information of the each one of the plurality of speakers which is stored in the filtering information storage means;
identification information acquisition means for acquiring, when one of the plurality of speakers is newly connected, identification information of the newly connected one of the plurality of speakers from the newly connected one of the plurality of speakers;
acoustic characteristics acquisition means for acquiring acoustic characteristics of the newly connected one of the plurality of speakers from a server for managing acoustic characteristics of each of the plurality of speakers, by notifying the identification information acquired by the identification information acquisition means to the server;
filtering information generation means for generating filtering information for making an audio reproduction signal output from the newly connected one of the plurality of speakers close to predetermined acoustic characteristics by comparing the acoustic characteristics acquired by the acoustic characteristics acquisition means to the predetermined acoustic characteristics; and
filtering information registration means for registering the filtering information generated by the filtering information generation means, in the filtering information storage means in association with the newly connected one of the plurality of speakers.

2. The audio device according to claim 1, further comprising:
connection permission and rejection inquiry means for issuing, in a case in which the acoustic characteristics acquisition means fails to acquire the acoustic characteristics of the newly connected one of the plurality of speakers, an inquiry to a user about whether to establish connection to the newly connected one of the plurality of speakers, by displaying a message that informs of the failure on a controller for remotely operating the audio device or on a display device included in the audio device; and
output control means for restricting, when the connection permission and rejection inquiry means receives connection rejection from the user with respect to the newly connected one of the plurality of speakers, output of an audio reproduction signal to the newly connected one of the plurality of speakers.

3. An audio system, comprising a plurality of speakers and an audio device for reproducing and outputting an audio signal with use of the plurality of speakers,
wherein the audio device includes:
filtering information storage means for storing filtering information for each one of the plurality of speakers connected to the audio device;
correction means for correcting, for each one of the plurality of speakers connected to the audio device, an audio reproduction signal to be output to the each one of the plurality of speakers, in accordance with the filtering information of the each one of the plurality of speakers which is stored in the filtering information storage means;
identification information acquisition means for acquiring, when one of the plurality of speakers is newly connected, identification information of the newly connected one of the plurality of speakers from the newly connected one of the plurality of speakers;
acoustic characteristics acquisition means for acquiring acoustic characteristics of the newly connected one of the plurality of speakers from a server for managing acoustic characteristics of each of the plurality of speakers, by notifying the identification information acquired by the identification information acquisition means to the server;
filtering information generation means for generating filtering information for making an audio reproduction signal output from the newly connected one of the plurality of speakers close to predetermined acoustic characteristics by comparing the acoustic characteristics acquired by the acoustic characteristics acquisition means to the predetermined acoustic characteristics; and
filtering information registration means for registering the filtering information generated by the filtering information generation means, in the filtering information storage means in association with the newly connected one of the plurality of speakers, and
wherein each one of the plurality of speakers includes identification information transmission means for transmitting identification information of the each one of the plurality of speakers to the audio device when the each one of the plurality of speakers is connected to the audio device.

4. A program for causing a computer to function as an audio device for reproducing and outputting an audio signal with use of a plurality of speakers,
the program causing the computer to function as:
filtering information storage means for storing filtering information for each one of the plurality of speakers connected to the computer;
correction means for correcting, for each one of the plurality of speakers connected to the computer, an audio reproduction signal to be output to the each one of the plurality of speakers, in accordance with the filtering information of the each one of the plurality of speakers which is stored in the filtering information storage means;
identification information acquisition means for acquiring, when one of the plurality of speakers is newly connected to the computer, identification information of the newly connected one of the plurality of speakers from the newly connected one of the plurality of speakers;
acoustic characteristics acquisition means for acquiring acoustic characteristics of the newly connected one of the plurality of speakers from a server for managing acoustic characteristics of each of the plurality of speakers, by notifying the identification information acquired by the identification information acquisition means to the server;
filtering information generation means for generating filtering information for making an audio reproduction signal output from the newly connected one of the plurality of speakers close to predetermined acoustic characteristics by comparing the acoustic characteristics acquired by the acoustic characteristics acquisition means to the predetermined acoustic characteristics; and
filtering information registration means for registering the filtering information generated by the filtering information generation means, in the filtering information storage means in association with the newly connected one of the plurality of speakers.

5. A method of setting an audio reproduction environment in an audio system including a plurality of speakers and an audio device for reproducing and outputting an audio signal with use of the plurality of speakers, the method comprising:
correcting, by the audio device, for each one of the plurality of speakers connected to the audio device, an audio reproduction signal to be output to the each one of the plurality of speakers, in accordance with a piece of filtering information that is registered in association with the each one of the plurality of speakers;
acquiring, by the audio device, when one of the plurality of speakers is newly connected, identification information of the newly connected one of the plurality of speakers from the newly connected one of the plurality of speakers;
acquiring, by the audio device, acoustic characteristics of the newly connected one of the plurality of speakers from a server for managing acoustic characteristics of each of the plurality of speakers, by notifying the acquired identification information to the server;
generating, by the audio device, filtering information for making an audio reproduction signal output from the newly connected one of the plurality of speakers close to predetermined acoustic characteristics by comparing the acquired acoustic characteristics to the predetermined acoustic characteristics;
registering, by the audio device, the generated filtering information in association with the newly connected one of the plurality of speakers; and
transmitting, by one of the plurality of speakers, identification information of the one of the plurality of speakers to the audio device when the one of the plurality of speakers is connected to the audio device.
